(19) United States
(12) Patent Application Publication
(10) Pub. No.: US 2018/0067632 A1
(43) Pub. Date: Mar. 8, 2018

(54) USER TERMINAL APPARATUS AND CONTROL METHOD THEREOF

(71) Applicants: SAMSUNG ELECTRONICS CO., LTD., Suwon-si (KR); BENJAMIN HUBERT, LTD., London (GB)

(72) Inventors: Soo-yeoun YOON, Suwon-si (KR); Benjamin HUBERT, London (GB)

(21) Appl. No.: 15/698,920

(22) Filed: Sep. 8, 2017

(30) Foreign Application Priority Data
Sep. 8, 2016 (KR) 10-2016-0115707

(51) Int. Cl. G06F 3/0484; G06F 3/14

(52) U.S. Cl. CPC G06F 3/04845; G06F 3/04817; G06F 3/1454; G06F 3/04842

(57) ABSTRACT

A user terminal apparatus is provided. The user terminal apparatus includes a communicator comprising communication circuitry, a display, and a processor configured to control the display to display a user interface (UI) for generating a pattern image, and in response to a content being selected, to generate a content in which the selected content is expressed as a pattern image generated through the UI, and to control the communicator to transmit the generated content to the display apparatus.

### CROSS-REFERENCE TO RELATED APPLICATION

This application is based on and claims priority under 35 U.S.C. § 119 to Korean Patent Application No. 10-2016-0115707, filed in the Korean Intellectual Property Office on Sep. 8, 2016, the disclosure of which is incorporated by reference herein in its entirety.

### BACKGROUND

### 1. Field

The present disclosure relates generally to a user terminal apparatus and a control method thereof, and for example, to a user terminal interlocked with a display apparatus, and a control method thereof.

### 2. Description of Related Art

There are various kinds of contents that a user enjoys in a mobile device, and techniques for providing different kinds of fun by applying and modifying such contents are being advanced. For example, in a smart phone or the like, modifying content such as a photograph using a designated filter can provide a fun viewing experience to the user.

However, the conventional techniques are limited to simply modifying the content using a designated filter in the mobile device, but have not yet reached the stage of providing more familiar and interesting artwork to the user by modifying the content selected by the user by adding only the user's element and linking it with the large screen.

Accordingly, there is a demand for providing a more familiar and interesting content viewing opportunity to the user.

### SUMMARY

One or more example embodiments of the present disclosure provide a user terminal and a control method thereof that can provide user-friendly artwork through a large screen.

According to an example aspect of an example embodiment, a user terminal apparatus is provided, including: a communicator comprising communication circuitry; a display; and a processor configured to control the display to display a user interface (UI) for generating a pattern image in response to a content being selected, to generate a content in which the selected content is expressed as a pattern image generated through the UI, and to control the communicator to transmit the generated content to the display apparatus.

The processor may provide a basic pattern image on the UI, and generate the pattern image by editing at least one of a shape, size and color of the basic pattern image according to a user's manipulation.

The processor may display a plurality of GUIs arranged in a peripheral area of the basic pattern image, in response to a movement command being received with respect to at least one of the plurality of GUIs, move at least one of the plurality of GUIs based on the movement command, and modify a shape and size of the basic pattern image to correspond to a position of the moved GUI.

The pattern image may include a pattern image determined according to a user's manipulation and an additional pattern image generated based on the determined pattern image, and the additional pattern image may include at least one additional pattern image that differs in at least one of a color and size from the determined pattern image.

The processor may determine a position in which the pattern image is to be arranged based on a color of the content, and generate the content by arranging the pattern image in the determined position.

The processor may arrange a pattern image of a relatively dark color among the pattern images or overlap at least two pattern images in an area of a relatively dark color in the content, and arrange a pattern image of a relatively bright color among the pattern images in an area of a relatively bright color in the content.

According to an example aspect of another example embodiment, a controlling method of a user terminal apparatus is provided, the method comprising:

generating a pattern image through a UI for generating a pattern image; generating a content in which a content selected by a user is expressed as the generated pattern image; and transmitting the generated content to a display apparatus in communication with the user terminal apparatus.

The generating the pattern image may include providing a basic pattern image on the UI, and generating the pattern image by editing at least one of a shape, size and color of the basic pattern image according to a user's manipulation.

The generating the pattern image may include displaying a plurality of GUIs arranged in a peripheral area of the basic pattern image, in response to a movement command being received with respect to at least one of the plurality of GUIs, moving at least one of the plurality of GUIs based on the movement command, and modifying a shape and size of the basic pattern image to correspond to a position of the moved GUI.

The pattern image may include a pattern image determined according to a user's manipulation and an additional pattern image generated based on the determined pattern image, and the additional pattern image may include at least one additional pattern image that differs in at least one of a color and size from the determined pattern image.

The generating the content may include determining a position in which the pattern image is to be arranged based on a color of the content, and generating the content by arranging the pattern image in the determined position.

The generating the content may include arranging a pattern image of a relatively dark color among the pattern images or overlapping at least two pattern images in an area of a relatively dark color in the content, and arranging a pattern image of a relatively bright color among the pattern images in an area of a relatively bright color in the content.

According to an example aspect of another example embodiment, a display system is provided, comprising: a user terminal apparatus configured to display a UI for generating a pattern image, and to generate a content in which the selected content is expressed as a pattern image generated through the UI in response to a content being selected; and a display apparatus configured to receive the generated content from the user terminal apparatus and display the received content.

According to the various example embodiments of the present disclosure, a variety of contents owned by the user can be provided to the user through a large screen by providing artwork that is directly drawn by the user or modified in accordance with the selected pattern, thereby providing a new type of viewing opportunity to the user.

### BRIEF DESCRIPTION OF THE DRAWINGS

The above and other aspects, features and attendant advantages of the present disclosure will become more apparent and readily appreciated from the following detailed description, taken in conjunction with the accompanying drawings, in which like reference numerals refer to like elements, and wherein:

FIG. 1 is a diagram illustrating an example display system including a user terminal apparatus and a display apparatus according to an example embodiment;

FIG. 2 is a block diagram illustrating an example configuration of a user terminal apparatus according to an example embodiment;

FIGS. 3A, 3B, 3C, 3D and 3E are diagrams illustrating an example method of generating a pattern image according to an example embodiment;

FIG. 4 is a diagram illustrating an example method for selecting a content to be modified according to an example embodiment;

FIGS. 5A, 5B and 5C are diagrams illustrating an example method of transmitting a modified content by interlocking a user terminal apparatus and a display apparatus according to an example embodiment;

FIGS. 6A and 6B are diagrams illustrating an example displaying method of a user terminal apparatus in a state where a modified content is transmitted according to an example embodiment;

FIG. 7 is a diagram illustrating an example embodiment in which a content modified in a display apparatus is sequentially expressed according to an example embodiment;

FIGS. 8, 9, 10 and 11 are diagrams illustrating an example method of expressing various contents in pattern images and displaying the same according to various example embodiments;

FIGS. 12 and 13 are flowcharts illustrating an example operation process of a display system according to various example embodiments;

FIG. 14 is a block diagram illustrating an example configuration of a user terminal apparatus according to an example embodiment; and

FIG. 15 is a flowchart illustrating an example control method of a user terminal apparatus according to an example embodiment.

### DETAILED DESCRIPTION

Prior to explaining the various example embodiments of the present disclosure, an explanation will be made on a method by which the various example embodiments of the present disclosure and drawings are disclosed.

The example embodiments of the present disclosure may be diversely modified. Accordingly, specific example embodiments are illustrated in the drawings and are described in greater detail in the detailed description. However, it is to be understood that the present disclosure is not limited to a specific example embodiment, but includes all modifications, equivalents, and substitutions without departing from the scope and spirit of the present disclosure. Also, well-known functions or constructions may not be described in detail if they would obscure the disclosure with unnecessary detail.

The terms used in the present disclosure and the claims are general terms selected in consideration of the functions of the various embodiments of the present disclosure. However, these terms may vary depending on intention, legal or technical interpretation, emergence of new technologies, and the like of those skilled in the related art. Further, some of the terms may be arbitrarily selected. Unless there is a specific definition of a term, the term may be construed based on the overall contents and technological common sense of those skilled in the related art.

Further, like reference numerals indicate like components that perform substantially the same functions throughout the specification. For the sake of explanation and understanding, different embodiments are described with reference to like reference numerals. That is, even if all the components in the plurality of drawings have like reference numerals, it does not mean that the plurality of drawings refer to only one embodiment.

Further, the terms including numerical expressions such as a first, a second, and the like may be used to explain various components, but there is no limitation thereto. These terms are used only for the purpose of differentiating one component from another, without limitation thereto. For example, a numerical expression combined with a component should not limit the order of use or order of arrangement of the component. When necessary, the numerical expressions may be exchanged between components.

The singular expression also includes the plural meaning as long as it does not conflict in context. In this specification, terms such as ‘include’ and ‘have/has’ should be construed as designating that there are such characteristics, numbers, operations, elements, components or a combination thereof in the specification, not to exclude the existence or possibility of adding one or more of other characteristics, numbers, operations, elements, components or a combination thereof.

In the embodiments of the present disclosure, terms such as “module”, “unit”, “part”, and the like are terms used to indicate components that perform at least one function and operation, and these components may be realized in hardware, software or in combination thereof. Further, except for when each of a plurality of “modules”, “units”, “parts”, and the like needs to be realized in an individual hardware, the components may be integrated in at least one module or chip and be realized in at least one processor (not illustrated).

Further, in embodiments of the present disclosure, when it is described that a portion is connected to another portion, the portion may be either connected directly to the other portion, or connected indirectly via another medium. Further, when it is described that a portion includes another component, it does not exclude the possibility of including other components, that is, the portion may further include other components besides the described component.

Hereinafter, various example embodiments of the present disclosure will be explained with reference to the drawings.

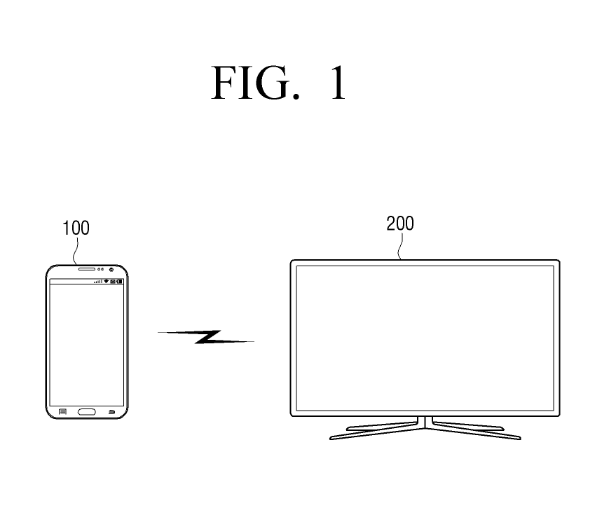

FIG. 1 is a diagram illustrating an example display system including a user terminal apparatus and a display apparatus according to an example embodiment.

Referring to FIG. 1, the display system according to an example embodiment includes a user terminal apparatus 100 and a display apparatus 200.

The user terminal apparatus 100 of the present disclosure may include a device capable of transmitting a file composed of various types of contents such as an image file including photographs, pictures, etc., a video file, an audio file, and a text file to an external device, or the like, but is not limited thereto, and it preferably refers to a device that can be carried by a user. For example, the user terminal apparatus 100 may be implemented as a notebook computer, a tablet PC, a smart phone, a portable terminal, a PDA (Personal Digital Assistant), MP3, a smart appliance, and a wearable device including smart glasses and a smart watch, or the like, but is not limited thereto.

Meanwhile, the display apparatus 200 of the present disclosure may include a device capable of receiving a file composed of various types of contents as described above from an external device, and means a device having a display capable of displaying contents.

FIG. 1 illustrates an example embodiment in which the user terminal apparatus 100 of the present disclosure is implemented as a smart phone carried by a user, and the display apparatus 200 is implemented as a TV. As illustrated in FIG. 1, the user transmits content to the display apparatus 200 through the user terminal apparatus 100, and the display apparatus 200 may display the content received from the user terminal apparatus 100. At this time, the display apparatus 200 may process the received content in various ways and display it. At this time, the content may be displayed by mirroring the other one of the user terminal apparatus 100 and the display apparatus 200.

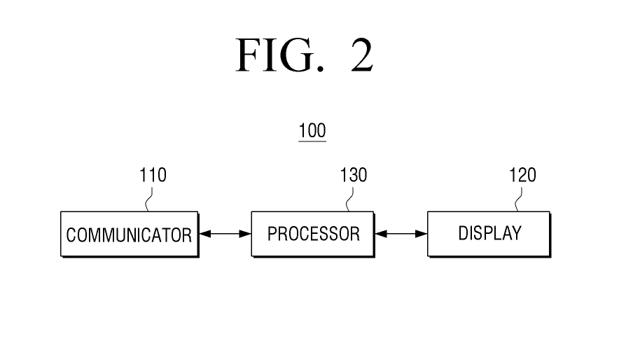

Meanwhile, the user terminal apparatus 100 must communicate with the display apparatus 200 in order to transmit the content to the display apparatus 200. The communication may include both wired and wireless communication, and the method may include various communication methods using radio frequency (RF) and infrared (IR), such as a local area network (LAN), a cable, a wireless LAN, a cellular service, a device to device (D2D) service, Bluetooth, Bluetooth low energy (BLE), 3rd generation (3G), Wi-Fi, long term evolution (LTE), ad hoc method Wi-Fi direct and LTE direct, ZigBee and Near Field Communication (NFC), or the like, but is not limited thereto. To this end, the user terminal apparatus 100 and the display apparatus 200 should be equipped with communication devices (e.g., including communication circuitry) of the same type so as to be able to communicate with each other, and this will be described in greater detail with reference to FIG. 2.

Meanwhile, the user terminal apparatus 100 may operate as a remote controller for controlling the operation of the display apparatus. The user terminal apparatus 100 may control the operation of the display apparatus 200 by irradiating infrared rays of a predetermined frequency to the display apparatus 200 according to a user's operation. In this case, the display apparatus 200 may receive the radiated infrared ray, convert the same to an electric signal corresponding to the frequency of the infrared ray, and perform various operations such as channel change or volume control of the display apparatus 100. A user can use the user terminal apparatus 100 to provide content to the display apparatus 200 and request presentation of the content.

In such a display system of the present disclosure, the content generated by the user's operation in the user terminal apparatus 100 is displayed on the display apparatus 200 having the large screen. Accordingly, a wider viewing environment can be provided for a wider view, and a plurality of users can share the viewing experience by watching the same contents together.

FIG. 2 is a block diagram illustrating an example configuration of a user terminal apparatus according to an example embodiment of the present disclosure. Referring to FIG. 2, a user terminal apparatus 100 may include, for example, a communicator (e.g., including communication circuitry) 110, a display 120 and a processor (e.g., including processing circuitry) 130.

The communicator 110 may include various communication circuitry and performs communication with the display apparatus 200. Specifically, the communicator 110 may perform communication with the display apparatus 200 through various communication methods using various communication circuitry, such as, for example, and without limitation, using a radio frequency (RF) and infrared (IR0, such as a local area network (LAN), a cable, a wireless LAN, a cellular service, a device to device (D2D) service, Bluetooth, Bluetooth low energy (BLE), 3rd generation (3G), Wi-Fi, long term evolution (LTE), ad hoc method Wi-Fi direct and LTE direct, ZigBee and NFC. For this purpose, the communicator 110 may include a communication module including communication circuitry used in each communication method, for example, and without limitation, a ZigBee communication module, a Bluetooth communication module, a BLE communication module, and a Wi-Fi communication module.

When a preset event such as input of a user command occurs, the communicator 110 may perform communication according to a preset communication scheme with the display apparatus 200 to be in an interlocked state. Here, the interlocking may refer, for example, to all the states in which the communication between the user terminal apparatus 100 and the display apparatus 200 becomes ready for communication, such as initialization of communication, operation of forming a network, and operation of performing device pairing.

For example, when communication is performed according to the Bluetooth communication method, the communicator 110 may perform a pairing with the display apparatus 200 through the Bluetooth communication module, and may communicate with the display apparatus 200.

In addition, when the ZigBee communication module is provided, the communicator 110 may perform a pairing with the display apparatus 200 through the ZigBee communication module and may communicate with the display apparatus 200.

The communicator 110 may also perform wireless communication with the display apparatus 200 using Wi-Fi, and the like. For example, the communicator 110 may be directly connected to the display apparatus 200 through communication circuitry, such as a Wi-Fi communication module without accessing a separate network, and may be connected to a network using an access point to perform communication with the display apparatus 200. As described above, the communicator 110 may perform communication with the display apparatus 200 through various communication methods using various communication circuitry.

The display 120 provides a screen displaying various contents. Specifically, the display 120 may display a user interface (UI) for generating a pattern image. The pattern image may be an image which serves as a basis for modifying a content selected by the user, which may be generated by a user's operation on the UI, and may include text, a graphic, a figure modified or drawn by a user, a specific image, and the like. For example, and without limitation, if the user generates a pattern image of a ‘star’ shape and selects a photographed image as the content to be modified, the selected photograph may be reproduced by being expressed as a pattern image of a ‘star’ shape. The UI screen for generating a pattern image may be a screen provided in an application including a pattern image generation tool capable of selecting a pattern image, modifying a pattern image, and drawing a pattern image, etc.

The display 120 may, for example, be implemented in various forms of displays such as a liquid crystal display (LCD) panel, organic light emitting diodes (OLED), a liquid crystal on silicon (LCoS), a digital light processing, or the like. However, the example is not limited thereto and the display 120 may be implemented as a flexible display, a transparent display, or the like, but is not limited thereto.

In addition, the display 120 may include a driving circuit, a backlight unit, and the like which may be implemented in forms such as an a-si TFT, a low temperature poly silicon (LTPS) TFT, an organic TFT (OTFT), and the like.

The display 120 may be implemented with a touch display which may input a user command through a user's touch. For example, the user may input desired information by touching various pieces of content displayed in the display 120 using a finger or an electronic pen. In this example, the display 120 may be implemented with a touch screen which serves to display the content and simultaneously serves as a touch pad. A tempered glass substrate, a protection film, and the like may be provided in a front of the display 120 in which a touch is accomplished to protect the display 120.

When the display 120 is implemented with such a touch display, a user command according to a touch input on the display, such as generating a pattern image according to a user drag input, can be received. In the following various example embodiments, it is assumed that the display 120 is implemented as a touch display.

The processor 130 may include various processing circuitry for controlling a general operation of the user terminal apparatus 100.

The processor 130 may generate a pattern image according to a user operation on the UI displayed on the display 120 and generate the content represented by the pattern image generated on the UI when the content is selected. The processor 130 may provide a pattern image generation tool capable of selecting and editing the shape, size, and color of the pattern image on the UI, and the user may generate a pattern image of various shapes, sizes, and colors using the pattern image generation tool.

The processor 130 may reconstruct the content selected by the user using the generated pattern image. A plurality of pattern images are arranged according to the color, brightness, etc. of the contents selected by the user, so that new contents similar to the contents can be generated. The processor 130 may place a pattern image having a relatively dark color among the pattern images in an area having a relatively dark color in the contents or may represent the dark color of the contents by overlapping at least two pattern images. In addition, the processor 130 may place a pattern image having a relatively bright color among the pattern images in an area having a relatively bright color in the contents to express a bright color of the content.

When a content represented by the pattern image is generated, the processor 130 may transmit the generated content to the display apparatus 200 and control the display apparatus 200 to display the generated content.

Hereinafter, a method of generating a pattern image, a method of generating a content image represented by a pattern image, and a method of transmitting a content image represented by a pattern image to a display device will be described in greater detail with reference to the accompanying drawings.

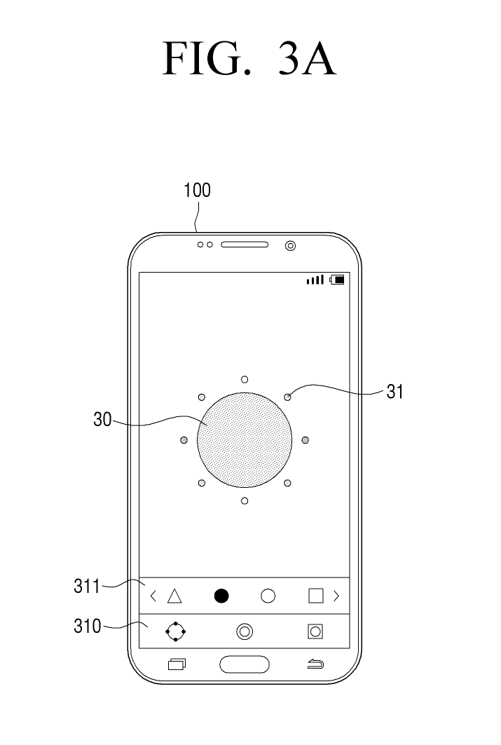

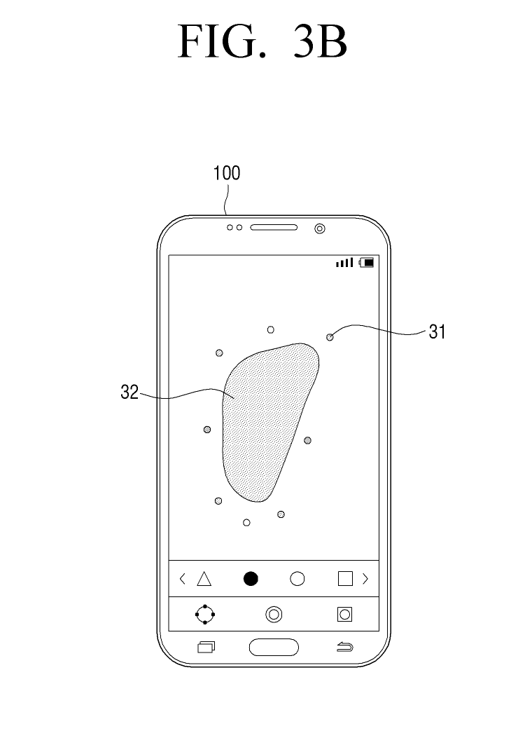

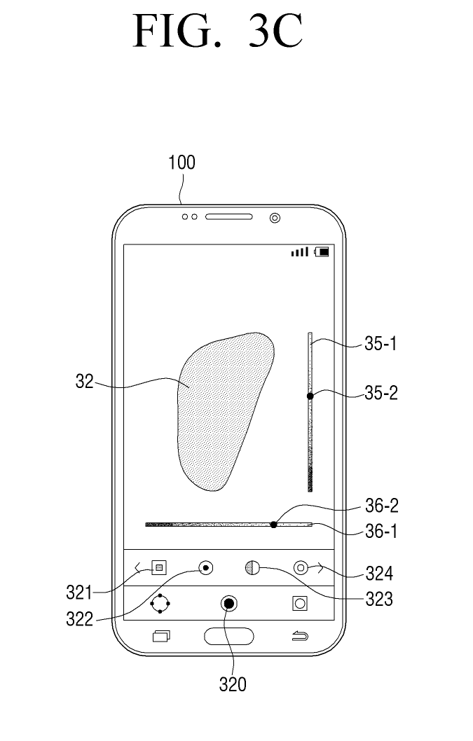

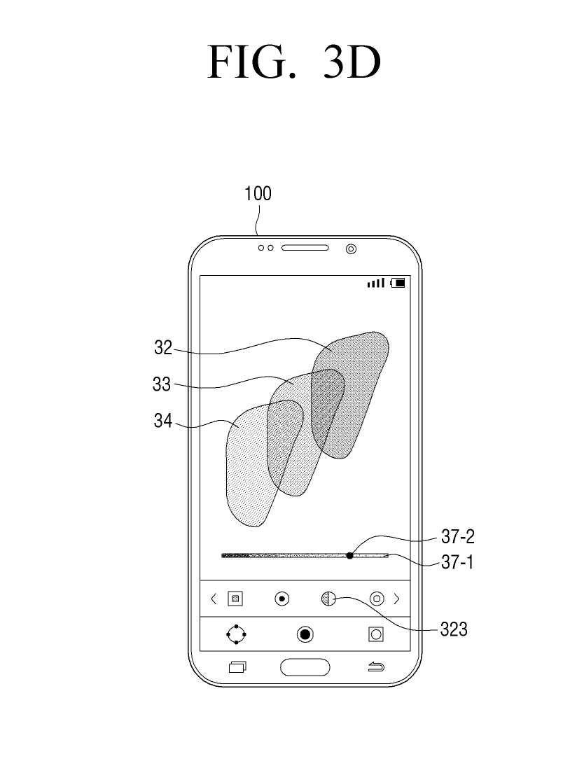

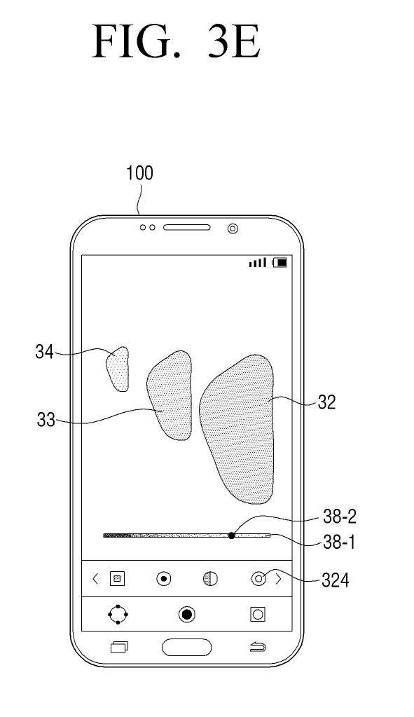

FIGS. 3A, 3B, 3C, 3D and 3E are diagrams illustrating an example method of generating a pattern image according to an example embodiment.

The processor 130 of the user terminal apparatus 100 may analyze the selected content and run an application having an algorithm capable of modifying the content according to the pattern image generated by the user. The application may provide a pattern image generation screen including a menu which allows a user to select a shape of a pattern image, a menu for selecting a color, luminance and size of the pattern image, and a menu for selecting a content stored in the user terminal apparatus 100 or a content provided from another application installed in the user terminal apparatus 100 as a content to be modified.

Referring to FIG. 3A, when a pattern image selection menu 310 is selected from among super ordinate menus of the pattern image generation screen, a menu 311 for selecting a shape of a basic pattern image may be displayed. In the displayed menu, the user may select a shape of a predetermined basic pattern image, such as triangle, circle, rectangle, polygon, and the like.

In the pattern image generation screen, a plurality of GUIs 31 for modifying a shape and size of the basic pattern image 30 may be arranged in the peripheral area of the basic pattern image 30 and displayed. As illustrated in FIG. 3A, the plurality of GUIs may be dot-shaped objects. In the case where the basic pattern image 30 is a circular shape, when the user inputs a movement command for at least one of the plurality of GUIs 31, the shape and size of the basic pattern image 30 are modified according to the movement. The movement command may be performed by a touch-and-drag input by a user's finger or a stylus pen.

As illustrated in FIG. 3B, the processor 130 may, according to a touch-and-drag input for at least one of the plurality of GUIs 31, move a GUI to which the touch-and-drag input is performed to correspond to a direction and distance of the touch-and-drag input, and modify the shape and size of the basic pattern image 30 to correspond to a position of the moved GUI.

By the above-mentioned method, when the shape is determined as the pattern image 32 illustrated in FIG. 3B, the color and brightness of the pattern image 32 may be changed. As illustrated in FIG. 3C, when a menu 320 for selecting the color, brightness and size of the pattern image is selected, a sub menu for selecting an outline color selection tool 321 of the pattern image, an internal color and brightness selection tool 322 of the pattern image 322, a color difference setting tool 323 of a plurality of pattern images, and a size change tool 324 of the pattern image may be displayed.

When the outline color selection tool 321 of the pattern image is selected, the color of the outline of the pattern image 32 may be selected, and when the internal color and brightness selection tool 322 of the pattern image is selected, the internal color and brightness of the pattern image 32 may be selected. For example, as illustrated in FIG. 3B, the internal color of the pattern image 32 may be selected by vertically moving an indicator 35-2 in the color selection tool 35-1 in a bar shape, and the brightness of the pattern image 32 may also be selected by horizontally moving an indicator 36-2 in the brightness selection tool 36-1 in a bar shape. The outline color and the outline brightness of the pattern image 32 may also be selected likewise. Although not illustrated in FIG. 3C, the menu 320 for selecting the color, brightness and size of the pattern image may include a tool for selecting a background color of a content represented by the pattern image 32, and the background color and brightness of the content represented by the pattern image 32 may be selected in the same method as the above-described method.

The processor 130 may automatically generate a plurality of pattern images of different colors based on the displayed pattern image 32. As illustrated in FIG. 3D, when the user selects the color difference setting tool 323 of a plurality of pattern images in the sub menu, two additional pattern images 33 and 34 may be further generated, and a bar 37-1 for selecting the degree of difference in colors of the plurality of generated pattern images 32, 33 and 34 and an indicator 37-2 may be provided. The added additional pattern images 33 and 34 have a different color from the pre-generated pattern image 32, and it is preferable that they have a large color difference from each other, such as complementary color. In addition, there is no limitation to the number of further generated additional pattern images, but it is preferable to have at least two of them. When the indicator 37-2 is moved in the provided bar 37-1, the size of the color difference between the plurality of pattern images 32, 33 and 34 may be adjusted. The additional pattern images 33 and 34 generated additionally may have different colors depending on the pre-generated pattern image 32 and predetermined criteria even if there is no adjustment to the size of the color difference.

As illustrated in FIG. 3E, the processor 130 may adjust the sizes of the plurality of generated pattern images 32, 33 and 34. When the user selects the size change tool 324 of a pattern image on the sub menu, a bar 38-1 for adjusting the size of the respective pattern images 32, 33 and 34 may be provided. When the user selects one of the pattern images 32, 33 and 34 and moves the indicator 38-2 in the provided bar 38-1, the processor 130 may adjust the size of the selected pattern image according to movement of the indicator 38-2. For example, when the indicator 38-2 moves to the right on the bar 38-1, the size of the selected pattern image may be increased, and when the indicator 38-2 moves to the left, the size of the selected pattern may be reduced.

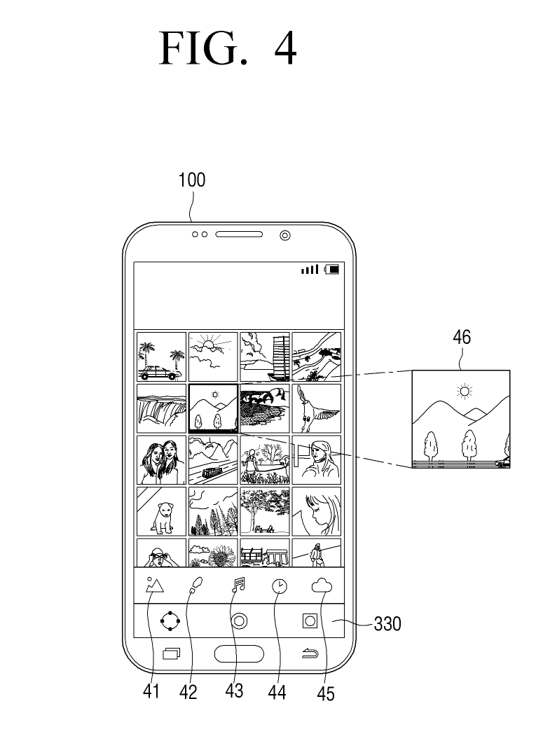

FIG. 4 is a diagram illustrating an example method for selecting a content to be modified according to an example embodiment.

When the user selects a menu 330 for selecting a content to be represented by a generated pattern image through the UI screen, a sub menu for selecting a type of content may be displayed, and the content may include various types of content such as images such as photographs 41, maps based on GPS 42, music 43, clocks 44 and weather 45. When the user selects an icon 41 for selecting a content of a type of image, such as photographs, from among sub menus allowing the user to selecting a type of content, a UI screen for selecting at least one of an image stored in the user terminal apparatus 100 and an image stored in an external server such as a cloud server may be displayed, and the image 46 selected on the UI screen may be selected as a content to be represented by a pre-generated pattern image. The processor 130 may provide a screen in which another application associated with a current application capable of selecting a pattern image and content, such as ‘gallery application’ capable of viewing images stored in the user terminal apparatus 100, is executed may be provided, and the user may select an image represented by a pattern image in the screen of the executed another application.

When the user selects an icon 42 capable of selecting a content of a GPS-based map type from among sub menus for selecting a type of the content, the processor 130 may display a GPS-based map provided in the current application itself capable of selecting the pattern image and content or may provide a screen in which another application associated with a current application, such as ‘map application’ capable of providing a GPS-based map, is executed.

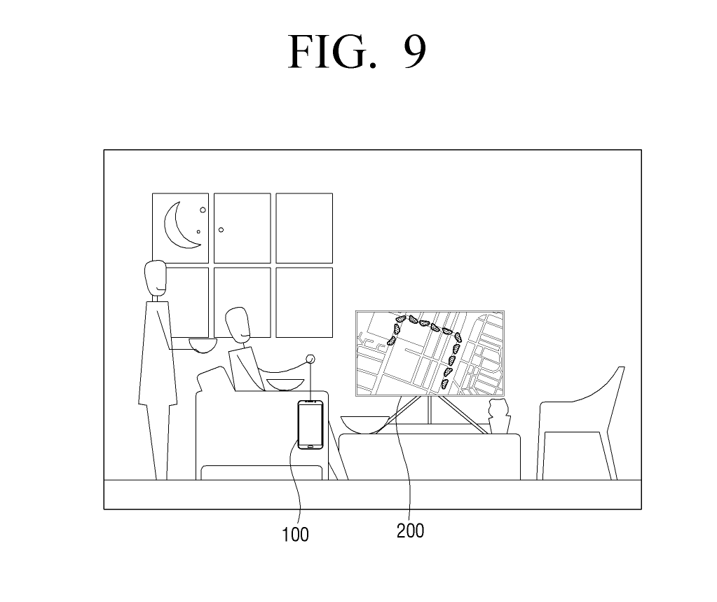

According to an example embodiment, the movement of the user (position change including the movement direction and the movement distance) tracked by the GPS for a specific time on the map provided on the screen may be expressed as a pre-generated pattern image. Detailed contents of this will be described with reference to FIG. 9.

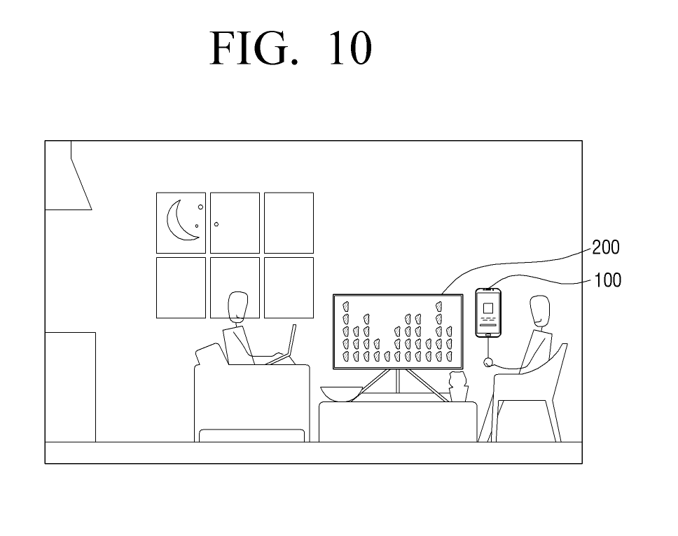

When the user selects an icon 43 for selecting music from among sub menus capable of selecting a type of content, the processor 130 may provide a screen capable of selecting any one of music (MP3, WMA, WAV, etc.) stored in the user terminal apparatus 100 or an external server. The processor 130 may provide a screen in which another application associated with a current application for selecting a pattern image and content is executed, such as ‘music player’ capable of playing music, and the user may select any one music in a screen of the executed another application. According to an example embodiment, a current application capable of selecting a pattern image and content or another associated application may have an equalizer for adjusting a frequency of music, and a graphic equalizer displayed when music is reproduced may be expressed as a pre-generated pattern image. Detailed contents of this will be described with reference to FIG. 10.

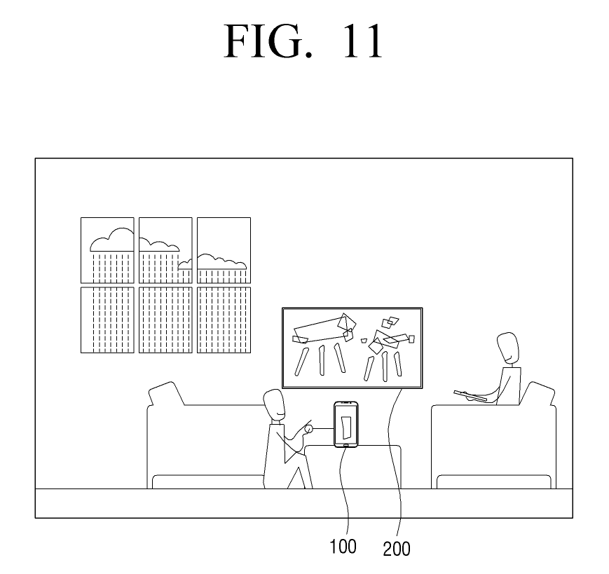

When the user selects a clock icon 44 from among a sub menu for selecting a type of content, at least one of the current date or the clock may be expressed as a pre-generated pattern, and when the user selects a weather icon 45 from among a sub menu capable of selecting a type of content, a GUI for expressing a current weather (clock, sun, rain, etc.) may be expressed as a pre-generated pattern image. A GUI expressing a current weather may be pre-stored in a current application capable of selecting a pattern image and a content, or may be received from an external server capable of providing weather information. Detailed contents of this will be described with reference to FIG. 11.

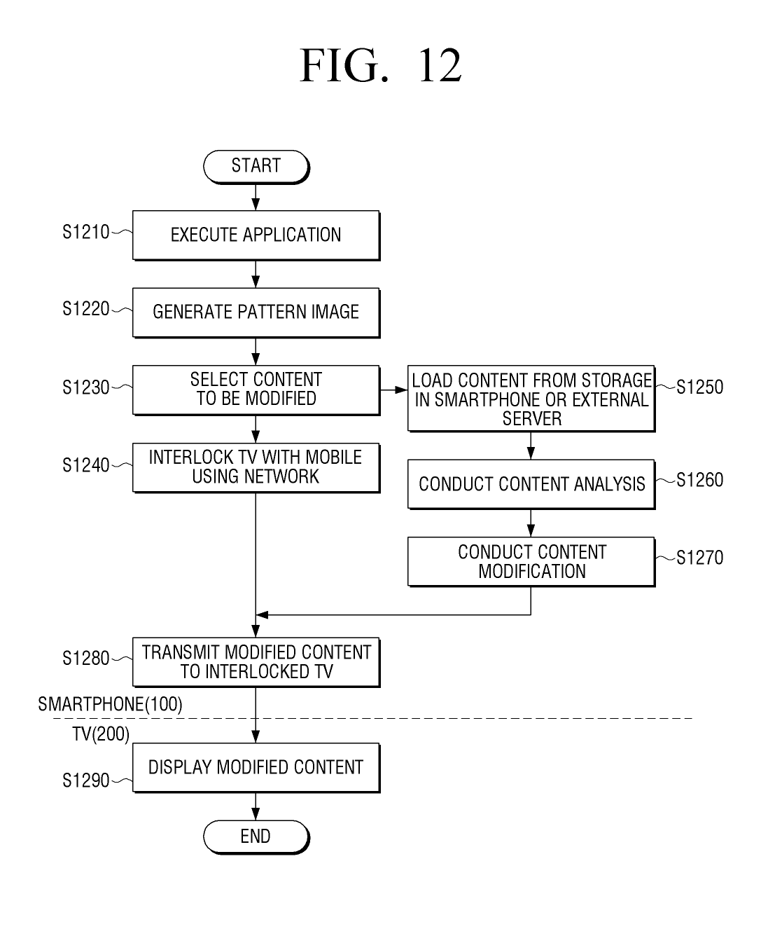

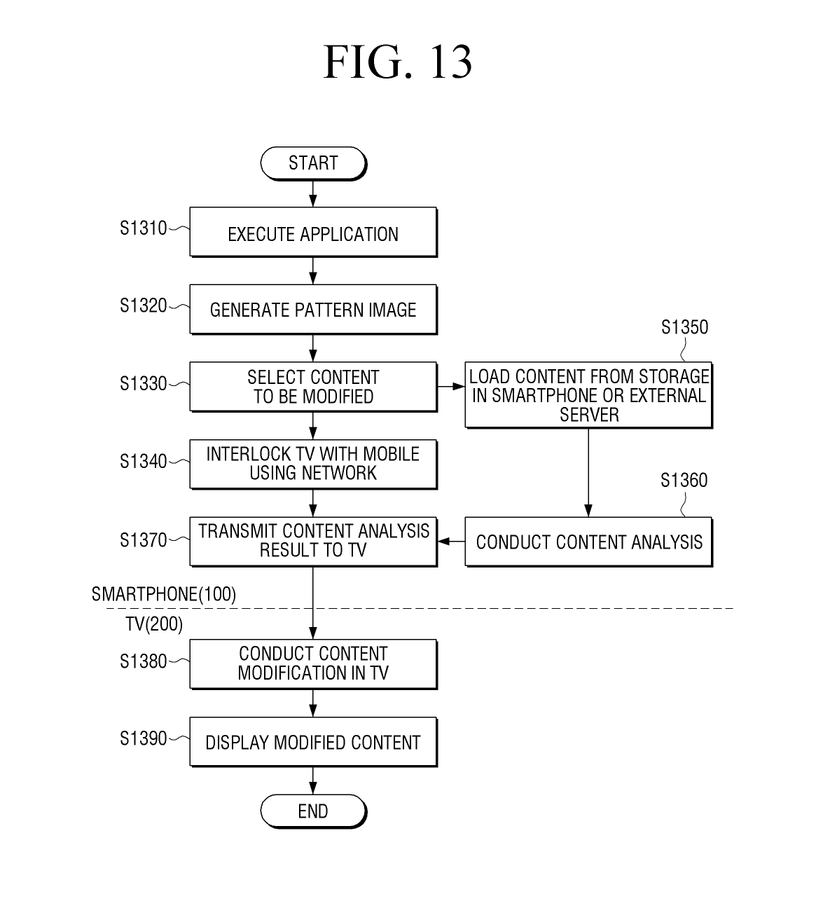

As described above, an image expressed as a pattern image, a user's movement expressed as a pattern image on a map, a graphic equalizer expressed as a pattern image, a date, time or weather expressed in a pattern image may be generated by the processor 130 of the user terminal apparatus 100 and transmitted to the display apparatus 200. However, the pattern image generated in the user terminal apparatus 100 and the selected content may be transmitted to the display apparatus 200, and the content expressed as the pattern image in the display apparatus 200 may be generated and displayed. Detailed contents of this will be described with reference to FIGS. 12 and 13.

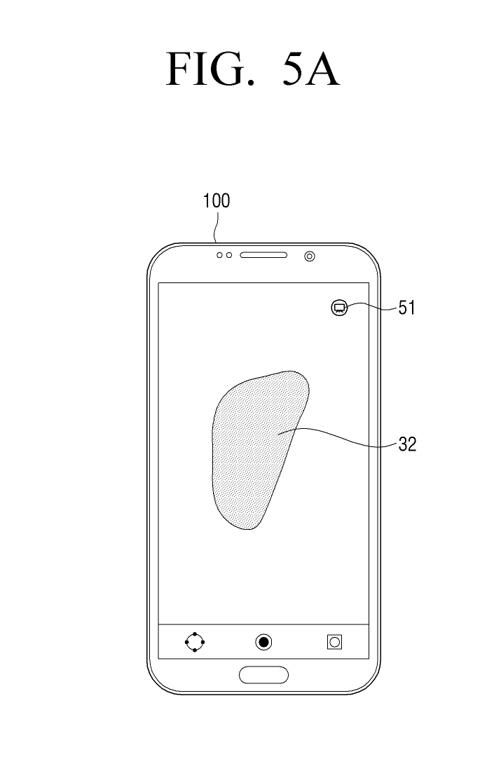

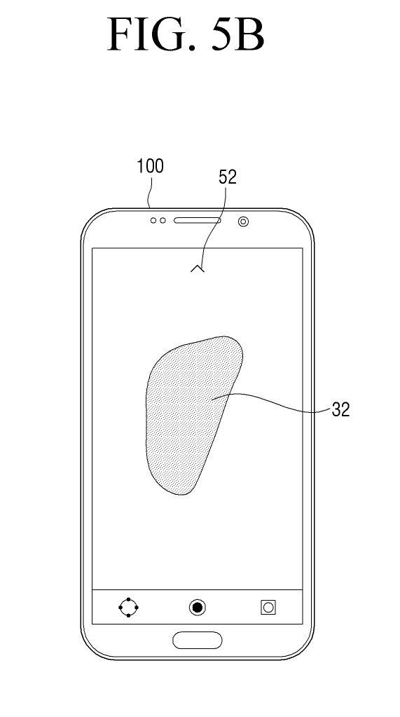

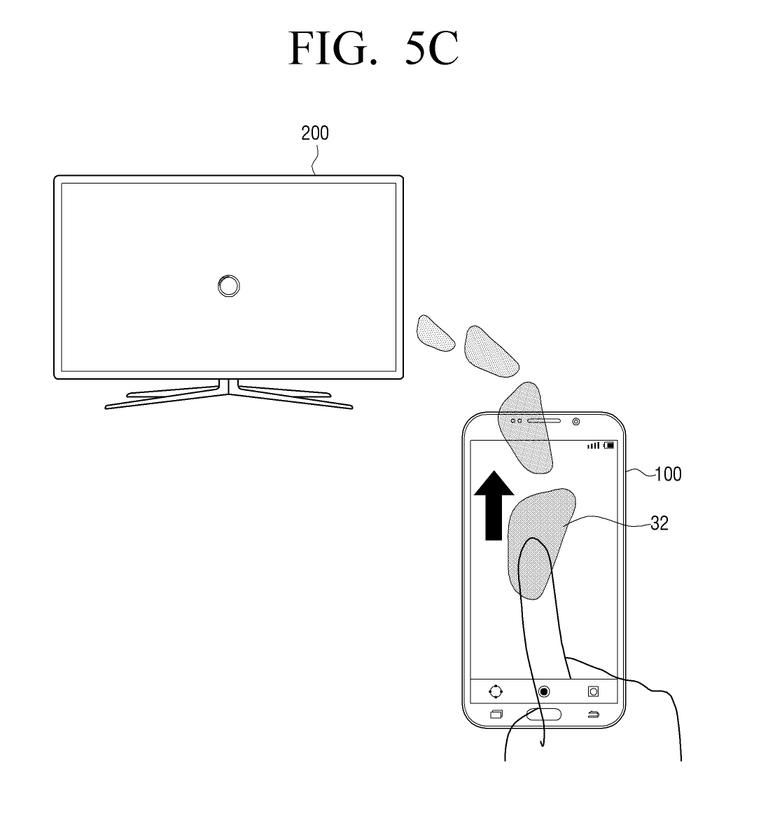

FIGS. 5A, 5B and 5C are diagrams illustrating an example method of transmitting a modified content by interlocking a user terminal apparatus and a display apparatus according to an example embodiment.

As illustrated in FIG. 5A, according to an example embodiment of the present disclosure, when the pattern image 32 is generated and selection of a content to be modified into the generated pattern image 32 and expressed is complete, a content in which the selected content as a pattern image may be generated, and an icon 51 for transmitting the generated content to the display apparatus 200 may be displayed. When the user selects the icon 51, the processor 130 may generate a new content in which the selected content is formed by a combination of pattern images 32, 34 and 35 based on characteristic information of a color, brightness and boundary, etc. of the selected content. When a new content is generated, the generated new content may be transmitted to the display apparatus 200.

As illustrated in FIG. 5B, according to another example embodiment of the present disclosure, a selected content may generate content expressed as a pattern image, and an icon 52 for transmitting the generated content to the displayed apparatus 200 may be displayed in the form of an arrowhead. In addition, when the user touches the icon 52 and drags the icon 52 to an upward direction of the user terminal apparatus 100, the processor 130 may generate a new content as described above, and transmit the generated new content to the display apparatus 200.

As illustrated in FIG. 5C, according to another example embodiment, the user may drag to an upward direction by directly touching the generated pattern image 32, and the processor 130 may, as described above, generate a new content and transmit the generated new content to the display apparatus 200.

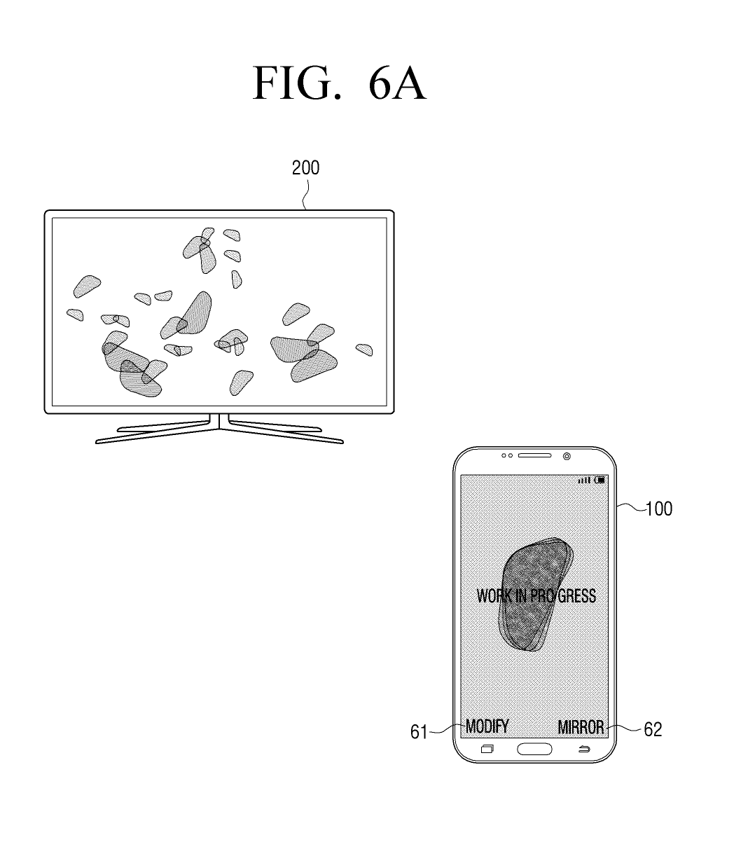

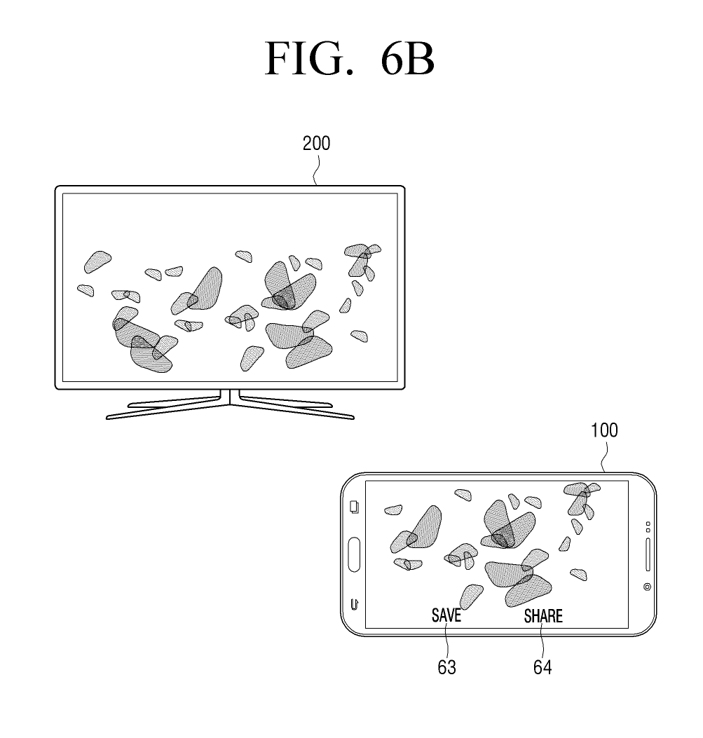

FIGS. 6A and 6B are diagrams illustrating an example displaying method of a user terminal apparatus in a state where a modified content is transmitted according to an example embodiment.

When the content modified by the method illustrated in FIGS. 5A-5C is transmitted to the display apparatus 200, the screen of the display apparatus 200 may display the modified content. As illustrated in FIG. 6A, in the screen of the display apparatus 200, the modified contents can be reconstructed while the pattern images 32, 33 and 34 forming the modified contents are gradually separated from each other and gathered over time.

The processor 130 of the user terminal apparatus 100 may display a guide message (“WORK IN PROGRESS”) indicating that a current operation is in progress through the display 120 during a time that is required for generating the modified content and transmitting the generated content. The screen displayed through the display 120 may be masked in a semi-transparent state. While the guide message is being displayed, the modification menu 61 and the mirror menu 62 may be provided on the display screen. When the user selects the modification menu 61, the processor 130 may re-display a UI screen including a pattern image generation tool capable of re-editing a pre-generated pattern image 32. When the user selects the mirror menu 62, the processor 130 receive information about a screen displayed on the display apparatus 200 from the display apparatus 200, and perform mirroring through the display 120. To this end, the processor 130 may receive a synchronization signal from the display apparatus 200 such that a screen provided by the display apparatus 200 and a screen displayed on the display 120 are synchronized with each other, or may transmit a synchronization signal to the display apparatus 200. As illustrated in FIG. 6B, when the user selects the mirror menu 61, a screen of the display apparatus 200 and a screen of the user terminal apparatus 100 are synchronized with each other and the same screen is displayed. Also, the screen of the user terminal apparatus 100 may display a save menu 63 and share menu 64. When the user selects the save menu 63, the modified content may be stored in the storage 140 of the user terminal apparatus 100. When the user selects may also select the share menu 64 and transmit the modified content to another user terminal apparatus or an external server.

The user terminal apparatus 100 may transmit the content generated by the display apparatus 200 at a time after the generation of the modified content is completed or may sequentially transmit only the portion where the generation is completed during the generation of the modified content. After the reception of the modified content is completed, the display apparatus 200 may configure and display the modified content over time. The display apparatus 200 may sequentially display only the portion where the reception is completed during the reception of the modified content and display the content according to the time. The user terminal apparatus 100 may display an option menu on the display 120 to set a time at which the modified content is constructed and displayed (at the time of completion of reception or during reception) and the time it takes to configure of the modified content through the display 120.

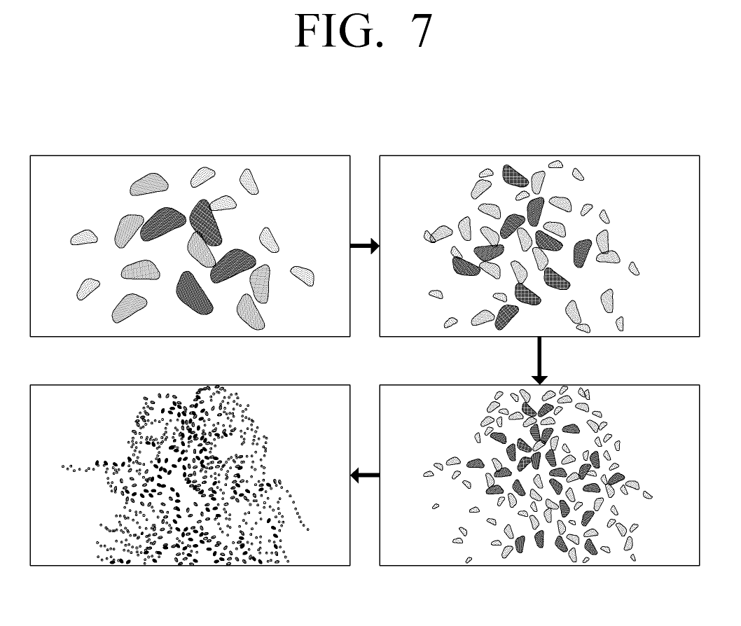

FIG. 7 is a diagram illustrating an example embodiment in which a content modified in a display apparatus is sequentially expressed according to an example embodiment.

As illustrated in FIG. 7, a plurality of pattern images generated in various colors and sizes may configure contents selected in the user terminal apparatus 100 sequentially in accordance with time on the screen displayed on the display apparatus 200. The display apparatus 200 may receive the pattern image and information related to disposition of the pattern image from the user terminal apparatus, and arrange the received pattern image based on the information related to disposition of the pattern image and display the arranged pattern image. The processor 130 of the user terminal apparatus 100 may determine a position in which the pattern image is to be arranged based on characteristic information, such as color, brightness, boundary information, and the like, of the selected content, and arrange the pattern image in the determined position and generate the modified content. The processor 130 may arrange a pattern image having a relatively dark color among a plurality of pattern images having a relatively dark color in the selected content, or overlap at least two pattern images. Also, the processor 130 may generate information controlling such that a pattern image having a relatively bright color is arranged in an area having a relatively bright color, and transmit the generated information to the display apparatus 200.

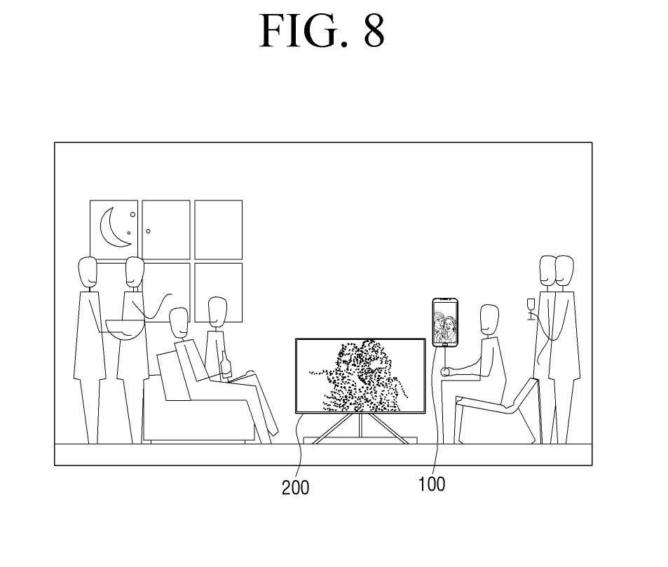

FIGS. 8, 9, 10 and 11 are diagrams illustrating an example method of expressing various contents in pattern images and displaying the same according to various example embodiments.

According to the example embodiment illustrated in FIG. 8, a content generated by modifying a photograph selected by the user from among the photographs stored in the user terminal apparatus 100 into a pattern image may be transmitted to the display apparatus 200, so that a plurality of viewers including the user may have an opportunity to view the modified content including a pattern image. The modified content may be transmitted through an external input of the display apparatus 200 and stored in the display apparatus 200. The modified content stored in the display apparatus 200 may be set as a screen saver by the user, and when there is no input to the display apparatus 200 for a predetermined time, the corresponding modified content may be displayed. As described above, the display apparatus 200 may display a process of sequentially arranging a plurality of pattern images to form a modified content.

According to the example embodiment illustrated in FIG. 9, in the map based on the GPS, the content modified so that the movement of the user (position change including the moving direction and the moving distance) tracked by the GPS for a specific time is represented by the generated pattern image may be transmitted to the display apparatus 200.

According to the example embodiment illustrated in FIG. 10, a content modified such that a graphic equalizer of music selected by the user from among the music stored in the user terminal apparatus 100 is expressed as a pre-generated pattern image may be transmitted to the display apparatus 200.

According to the example embodiment illustrated in FIG. 11, a content modified such that a GUI (cloud, sun, rain, etc.) expressing a current weather is expressed as a pre-generated pattern image may be transmitted to the display apparatus 200 so that a viewing experience may be shared by a plurality of users.

FIGS. 12 and 13 are flowcharts illustrating an example operation process of a display system according to various example embodiments. Hereinafter, it is assumed, to aid in understanding, that the user terminal apparatus 100 is a smartphone and that the display apparatus 200 is a TV, and it will be understood that the present disclosure is not limited to this illustrative example.

FIG. 12 is a flowchart illustrating example operation of a smartphone 100 and a TV 200 in an example embodiment in which the modified content is generated in the smartphone 100 and transmitted to the TV 200.

An application capable of generating a pattern image, select the generated pattern image and a content to be modified, and transmitting the selected pattern image and content to the TV 200 is executed, at operation S1210. When an operation command of the user is input through a UI provided on the executed application, a pattern image is generated according to the input operation command, at operation S1220. The user may select a content to be modified within the executed application, at operation S1230, and the content to be modified may be a content stored in the storage or a content that may be received from an external server (server serviced in the application, etc.). When the content to be modified is selected, an operation of interlocking with the TV 200 using network may be performed at operation S1240, and the content may be loaded from the storage within the smartphone 100 or from an external server, at operation S1250. Content analysis is performed in the smartphone 100 based on characteristic information of the content, such as color, brightness, boundary information, and the like, at operation S1260, and the content is modified based on the content analysis result, thereby generating a content in which the selected content is expressed as a pattern image, at operation S1270. The modified content may be transmitted from the smartphone 100 to the TV 200 interlocked with the smartphone 100, and the TV 200 which received the modified content may display the modified content, at operation S1290.

FIG. 13 is a flowchart illustrating example operation of a smartphone 100 and a TV 200 in an example embodiment in which the modified content is generated in the in the TV and displayed.

An application capable of generating a pattern image, select the generated pattern image and a content to be modified, and transmitting the selected pattern image and content to the TV 200 is executed, at operation S1310. When an operation command of the user is input through a UI provided on the executed application, a pattern image is generated according to the input operation command, at operation S1320. The user may select a content to be modified within the executed application, at operation S1330, and the content to be modified may be a content stored in the storage or a content that may be received from an external server (server serviced in the application, etc.). When the content to be modified is selected, an operation of interlocking with the TV 200 using network may be performed at operation S1340, and the content may be loaded from the storage within the smartphone 100 or from an external server, at operation S1350. Content analysis is performed in the smartphone 100 based on characteristic information of the content, such as color, brightness, boundary information, and the like, at operation S1360, and the content analysis result is transmitted to the TV 200, at operation S1370. The TV 200 may modify the content based on the received content analysis result to generate a content in which the selected content is expressed as a pattern image, at operation S1380, and display the generated content, at operation S1390.

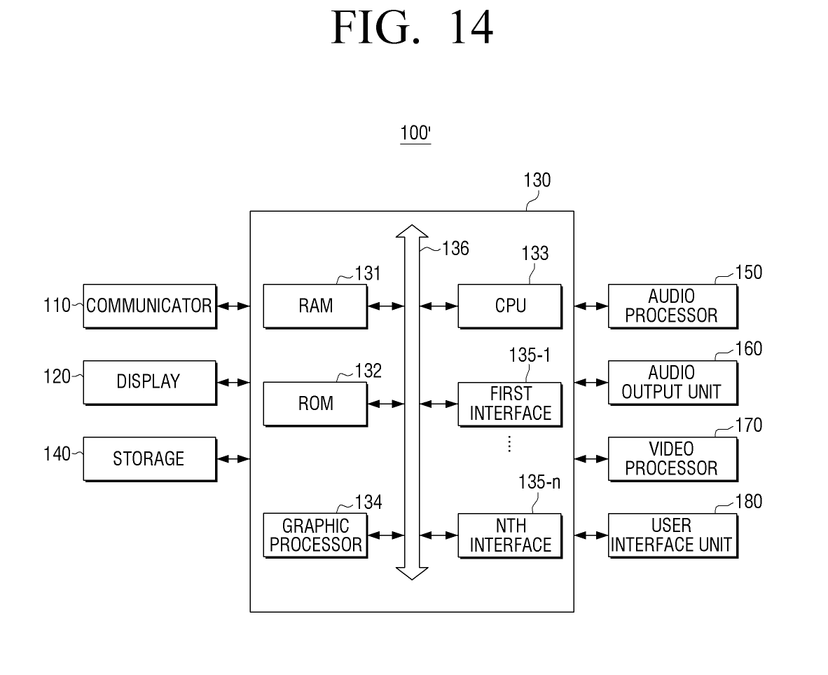

FIG. 14 is a block diagram illustrating an example configuration of a user terminal apparatus according to an example embodiment.

As illustrated in FIG. 14, the user terminal apparatus 100′ according to another example embodiment includes a communicator (e.g., including communication circuitry) 110, a display 120, a processor (e.g., including processing circuitry) 130, a storage unit 140, an audio processor (e.g., including audio processing circuitry) 150, an audio output unit (e.g., including audio output circuitry) 160, a video processor (e.g., including video processing circuitry) 170, and a user interface unit (e.g., including interface circuitry) 180. Hereinafter, descriptions of elements of FIG. 14 overlapping with descriptions of elements of FIG. 2 are omitted.

The processor 130 may include various circuitry, such as, for example, and without limitation, a random-access memory (RAM) 131, a read-only memory (ROM) 132, processing circuitry including, without limitation, a central processing unit (CPU) 133, processing circuitry including, without limitation, a graphic processor 134, a first to an n-th interface including various interface circuitry 135-1 to 135-n and a bus 136. Here, the RAM 131, the ROM 132, the CPU 133, the graphic processor 134, the first to nth interface 135-1˜135-n, and the bus 136 may be connected to one another through the bus 136.

The first to nth interfaces 135-1˜135-n are connected to the various elements mentioned above. One of the interfaces may also be a network interface connected to an external device through a network.

The CPU 133 accesses the storage 140 and performs booting using the O/S stored in the storage 140. The CPU 133 may also perform various operations by using various types of programs, contents, data, and the like stored in the storage 140.

The ROM 132 may store a command set, and the like for system booting. If a turn-on command is input and the power is supplied, the CPU 133 copies the O/S stored in the memory 140 into the RAM 131 according to the command stored in the ROM 132, and boots the system by executing the O/S. If booting is completed, the CPU 133 performs various operations by copying various types of application programs stored in the storage 140 into the RAM 131 and executing the application programs copied into the RAM 131.

The graphic processor 134 generates a screen including various types of objects such as an icon, an image, a text, and the like by using an operator and a renderer. The computing unit computes property values such as coordinates, shape, size, and color of each object to be displayed according to the layout of the screen. The renderer generates screens of various layouts including objects based on the attribute values calculated by the operator.

The operation of the processor 130 may be performed through execution of the program stored in the storage unit, e.g., memory 140.

The storage unit, e.g., memory 140 may store a variety of data such as an O/S software module for driving the user terminal apparatus 100′ and various types of multimedia content. Specifically, the storage 140 may include a base module processing a signal transferred from each hardware component included in the user terminal apparatus 100′, a storage module managing a DB or a registry, a security module, a communication module, a graphics processing module, an audio processing module, etc. The processor 130 may be configured to control the overall operations of the user terminal apparatus 100′ using various modules stored in the storage 140.

The audio processor 150 may include various audio processing circuitry that performs the processing for audio data. However, the audio data processing may be performed by an audio processing module stored in the storage 140.

The audio output unit 160 may include various audio output circuitry for outputting audio data processed by the audio processor 150. The audio output unit 160 may include, for example, and without limitation, a receiver terminal and a speaker.

The image processor 170 may include various video processing circuitry that performs various image processes such as decoding, scaling, noise filtering, frame rate converting, resolution converting, and the like for the contents. However, the video processing may be performed by an video processing module stored in the storage 140.

The user interface 180 may include various interface circuitry for sensing a user interaction for controlling the general operation of the user terminal apparatus 100′. For example, the user interface 180 may include various interface circuitry and/or apparatus, such as, for example, and without limitation, a microphone, a keyboard, a mouse, a touch sensor, a motion sensor, etc.

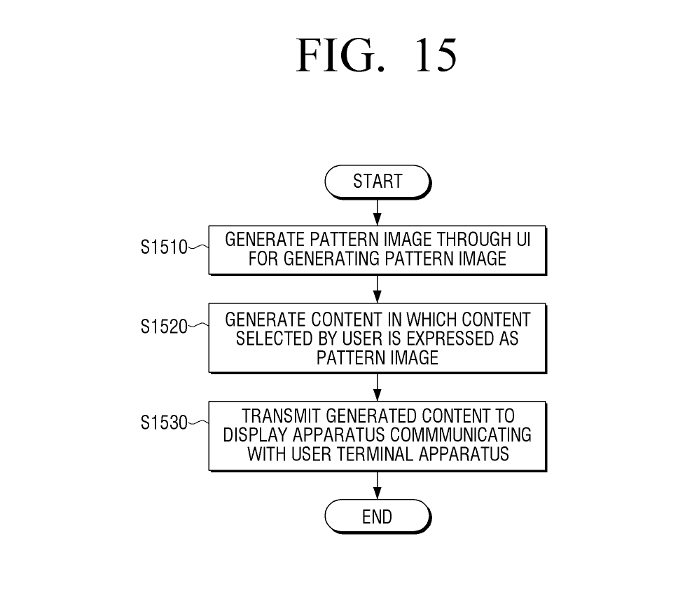

FIG. 15 is a flowchart illustrating an example control method of a user terminal apparatus according to an example embodiment.

A pattern image is generated through a UI for generating a pattern image, at operation S1510. Here, a pattern image may be generated in the method of providing a basic pattern image on the UI and editing at least one of a shape, size and color of the basic pattern image according to a user's manipulation. Specifically, in the case where a plurality of GUIs may be arranged and displayed in the peripheral area of the basic pattern image, when a movement command is received with respect to at least one of the plurality of UIs, at least one of the plurality of GUIs is moved according to the received movement command, and the shape and size of the basic pattern image may be modified to correspond to the position of the moved GUI.

Here, the pattern image may include a pattern image determined according to a user's manipulation and an additional pattern image generated based on the determined pattern image, and the additional pattern image may include at least one additional pattern image that differs at least one of the color and size from the determined pattern image.

Subsequently, a content in which the content selected by the user is expressed as a pattern image generated on the UI is generated at operation S1520. In this case, a position in which the pattern image is to be arranged is determined based on the color of the content, and a content in the form in which the pattern image is arranged in the determined position may be generated. Specifically, a pattern content in which pattern image having a relatively dark color among pattern images having a relatively dark color in the content is arranged or at least two pattern images are overlapped, and in which a pattern image having a relatively bright color among pattern images having a relatively bright color among the pattern images having a relatively bright color is arranged may be generated.

Subsequently, the generated content is transmitted to a display apparatus which communicates with the user terminal apparatus, at operation S1530.

According to the various embodiments of the present disclosure, it is possible to display an artwork in which various contents owned by the user is modified according to a pattern directly generated by the user on a large screen to provide a new viewing experience that was not previously available.

The control method of the user terminal apparatus according to various example embodiments may be implemented as programs which may be stored by various computer-readable media. For example, a computer program that has been processed by various processors and therefore has become capable of executing the aforementioned control methods may be stored in a non-transitory recording medium and be used.

For example, there may be provided a non-transitory computer readable medium that stores a program that performs a step of generating a pattern image through a UI for generating a pattern image, a step of generating a content in which a content selected by the user is expressed as a pattern image generated through the UI, and a step of transmitting the generated content to a display apparatus which communicates with the user terminal apparatus.

The non-transitory computer readable medium refers to a medium that stores data and is readable by an apparatus. In detail, the above-described various applications or programs may be stored in the non-transitory computer readable medium, for example, a compact disc (CD), a digital versatile disc (DVD), a hard disc, a Blu-ray disc, a universal serial bus (USB), a memory card, a read only memory (ROM), and the like, and may be provided.

While the present disclosure has been illustrated and described with reference to various example embodiments thereof, it will be understood by those skilled in the art that various changes in form and details may be made therein without departing from the spirit and scope of the present disclosure as defined by the appended claims and their equivalents.

What is claimed is:

1. A user terminal apparatus, comprising:
a communicator comprising communication circuitry;
a display; and
a processor configured to control the display to display a user interface (UI) for generating a pattern image, and in response to a content being selected, to generate a content in which the selected content is expressed as a pattern image generated through the UI, and to control the communicator to transmit the generated content to the display apparatus.

2. The user terminal apparatus as claimed in claim 1, wherein the processor is configured to provide a basic pattern image on the UI, and to generate the pattern image by editing at least one of: a shape, size and color of the basic pattern image based on a received manipulation.

3. The user terminal apparatus as claimed in claim 2, wherein the processor is configured to display a plurality of GUIs arranged in a peripheral area of the basic pattern image, and in response to a movement command being received with respect to at least one of the plurality of GUIs, to move at least one of the plurality of GUIs based on the movement command, and to modify a shape and/or a size of the basic pattern image to correspond to a position of the moved GUI.

4. The user terminal apparatus as claimed in claim 1, wherein the pattern image includes a pattern image determined based on a received manipulation and an additional pattern image generated based on the determined pattern image, and
wherein the additional pattern image includes at least one additional pattern image that differs in at least one of: a color and size from the determined pattern image.

5. The user terminal apparatus as claimed in claim 3, wherein the processor is configured to determine a position at which the pattern image is to be arranged based on a color of the content, and to generate the content by arranging the pattern image at the determined position.

6. The user terminal apparatus as claimed in claim 5, wherein the processor is configured to arrange a pattern image of a relatively dark color from among the pattern images or to overlap at least two pattern images in an area of a relatively dark color in the content, and to arrange a pattern image of a relatively bright color from among the pattern images in an area of a relatively bright color in the content.

7. A method of controlling a user terminal apparatus, the method comprising:
generating a pattern image through a UI for generating a pattern image;
generating a content in which a selected content is expressed as the generated pattern image; and
transmitting the generated content to a display apparatus for communicating with the user terminal apparatus.

8. The method as claimed in claim 7, wherein the generating the pattern image comprises providing a basic pattern image on the UI, and generating the pattern image by editing at least one of: a shape, size and color of the basic pattern image based on a received manipulation.

9. The method as claimed in claim 8, wherein the generating the pattern image comprises displaying a plurality of GUIs arranged in a peripheral area of the basic pattern image, and in response to a movement command being received with respect to at least one of the plurality of GUIs, moving at least one of the plurality of GUIs based on the movement command, and modifying a shape and/or size of the basic pattern image to correspond to a position of the moved GUI.

10. The method as claimed in claim 7, wherein the pattern image includes a pattern image determined based on a received manipulation and an additional pattern image generated based on the determined pattern image, and
wherein the additional pattern image includes at least one additional pattern image that differs in at least one of: a color and size from the determined pattern image.

11. The controlling method as claimed in claim 9, wherein the generating the content comprises determining a position at which the pattern image is to be arranged based on a color of the content, and generating the content by arranging the pattern image at the determined position.

12. The controlling method as claimed in claim 11, wherein the generating the content comprises arranging a pattern image of a relatively dark color from among the pattern images or overlapping at least two pattern images in an area of a relatively dark color in the content, and arranging a pattern image of a relatively bright color from among the pattern images in an area of a relatively bright color in the content.

13. A display system, comprising:
a user terminal apparatus configured to display a UI for generating a pattern image, and in response to a content being selected, to generate a content in which the selected content is expressed as a pattern image generated through the UI; and
a display apparatus configured to receive the generated content from the user terminal apparatus and display the received content.
